(19) United States
(12) Patent Application Publication
(10) Pub. No.: US 2008/0037568 A1
(43) Pub. Date: Feb. 14, 2008

(54) Method and Apparatus for Translating Data Packets From One Network Protocol to Another

(76) Inventors: Richard Eugene Anderson, Jericho, VT (US); Marc Raymond Faucher, South Burlington, VT (US); Christos John Georgiou, Scarsdale, NY (US); Francis E. Noel JR., Durham, NC (US)

Correspondence Address: BRACEWELL & PATTERSON, L.L.P., P.O. BOX 969, AUSTIN, TX, 78767-0969, US

(21) Appl. No.: 11/840,478

(22) Filed: Aug. 17, 2007

Related U.S. Application Data
(63) Continuation of application No. 10/605,621, filed on Oct. 14, 2003.

(51) Int. Cl. H04L 12/56

(52) U.S. Cl. 370/402

(57) ABSTRACT

A method for translating data packets from one network protocol to another is disclosed. A set of translation templates is constructed. The translation templates are then loaded into a translation template cache. In response to a data packet from a first network arriving at a translation router, an appropriate translation template is selected from the set of translation templates within the translation template cache according to the translation context of the data packet. Next, a new header for transmission into a second network is constructed by reading header fields of the data packet from the first network along with the appropriate translation template in the translation template cache. The data payload of the data packet from the first network is subsequently removed from the header of the data packet and then appended to the constructed header of the second network. Finally, the newly constructed data packet is transmitted to the second network.

### CROSS-REFERENCE TO RELATED APPLICATIONS

The present application is a continuation of U.S. patent application Ser. No. 10/605,621, filed on Oct. 14, 2003, and entitled “Method and Apparatus for Translating Data Packets from One Network Protocol to Another,” assigned to the assignee of the present invention and incorporated herein by reference in its entirety.

### BACKGROUND OF THE INVENTION

1. Technical Field

The present invention relates to network communications in general, and, in particular, to a method and apparatus for translating data packets. Still more particularly, the present invention relates to a method and apparatus for translating data packets from one network protocol to another.

2. Description of the Related Art

In a mixed protocol network environment, a significant amount of processing power of a network router is spent on translating data packet information from one protocol to another. Packet translation is a relatively time-consuming process. For a network storage environment, it is important to perform packet translation in an efficient manner in order to maintain an overall high system performance.

Conventionally, there are hardware solutions and software solutions for facilitating the packet translation process. One hardware solution is to construct packet headers with a state machine, but the problem with such solution is that there is no flexibility if network protocols change or migrate. Another hardware solution is to construct packet headers with a general purpose processor (GPP), but the problem with such solution is that long sequences of GPP instructions are required to execute protocol translations.

As for software solutions, information from the header or context block of a packet can be used to construct headers or frames. But the problem with such solution is that there are performance constraints from recalculations needed to be made for each translation.

Consequently, it is desirable to provide an improved method and apparatus for translating data packets between different network protocols.

### SUMMARY OF THE INVENTION

In accordance with a preferred embodiment of the present invention, a set of translation templates is constructed. The translation templates are then loaded into a translation template cache. In response to a data packet from a first network arriving at a translation router, an appropriate translation template is selected from the set of translation templates within the translation template cache according to the translation context of the data packet. Next, a new header for transmission into a second network is constructed by reading header fields of the data packet from the first network along with the appropriate translation template in the translation template cache. The data payload of the data packet from the first network is subsequently removed from the header of the data packet and then appended to the constructed header of the second network. Finally, the newly constructed data packet is transmitted to the second network.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a network environment to which a preferred embodiment of the present invention is applicable;

FIG. 2 is a block diagram of an apparatus for translating data packets between different network protocols, in accordance with a preferred embodiment of the present invention;

FIGS. 3a-3b are block diagrams of a translation template cache, in accordance with a preferred embodiment of the present invention;

FIG. 4 is a block diagram of a translation template for facilitating the translation of a received data packet to a Fibre Channel protocol, in accordance with a preferred embodiment of the present invention; and

FIG. 5 is a high-level logic flow diagram of a method for translating data packets from one protocol to another by using the apparatus from FIG. 2, in accordance with a preferred embodiment of the present invention.

### DETAILED DESCRIPTION OF A PREFERRED EMBODIMENT

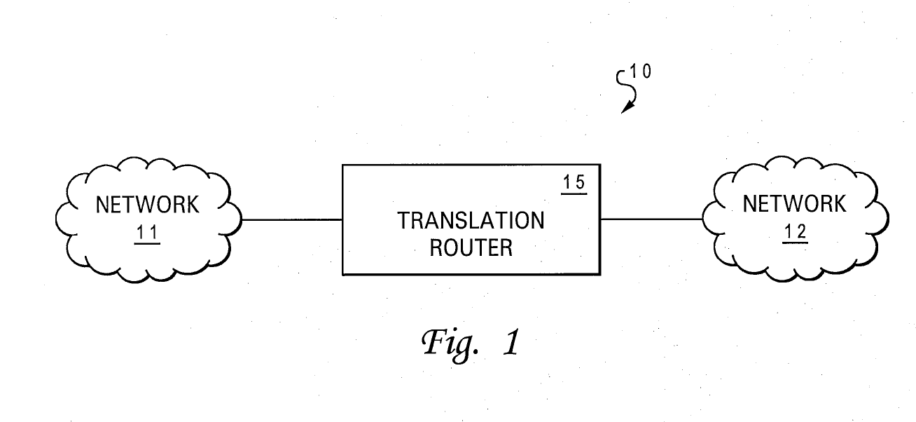

Referring now to the drawings and in particular to FIG. 1, there is depicted a block diagram of a network environment to which a preferred embodiment of the present invention is applicable. As shown, a network environment 10 includes a network 11 and a network 12. Each of network 11 and network 12 may have its own separate network protocol. For example, network 11 can be Ethernet while network 12 can be Fibre Channel, or network 11 can be Fibre Channel while network 12 can be InfiniBand. All communications between network 11 and network 12 are handled by a translation router 15. Translation router 15 is preferably a multi-protocol router. As a multi-protocol router, each port of translation router 15 is associated with a specific network protocol.

For example, if translation router 15 has three ports, port 1 of translation router 15 can be associated with Fiber Channel, port 2 of translation router 15 can be associated with Transmission Control Protocol/Internet Protocol (TCP/IP), and port 3 of translation router 15 can be associated with an InfiniBand. Thus, translation router 15 is aware of the type of network protocol to which a network packet belongs based on the incoming port number from which the network packet comes. Similarly, translation router 15 is aware of the type of network protocol to which a network packet should be translated based on the outgoing port number to which the network packet is to be transmitted.

Within a network environment, such as network environment 10, the processing overhead can be relatively high because of the large number of data packets that needed to be dealt with. However, within the network environment, there are also a couple of features that can be used to alleviate the above-mentioned problem. First, although there are numerous network protocols that are being in-use, the total number of different network protocols are relatively small and the specifics of each network protocol are well defined by various governing standards. Second, most network protocols use a header structure ahead of the payload in a packet containing packet description information such as network source and destination addresses, type of packet, etc. The present invention leverages the above-mentioned two attributes in order to pre-build the necessary set of translation template caches as well as constructing the algorithms necessary to fill a particular destination translation template caches from any of the possible input network protocols.

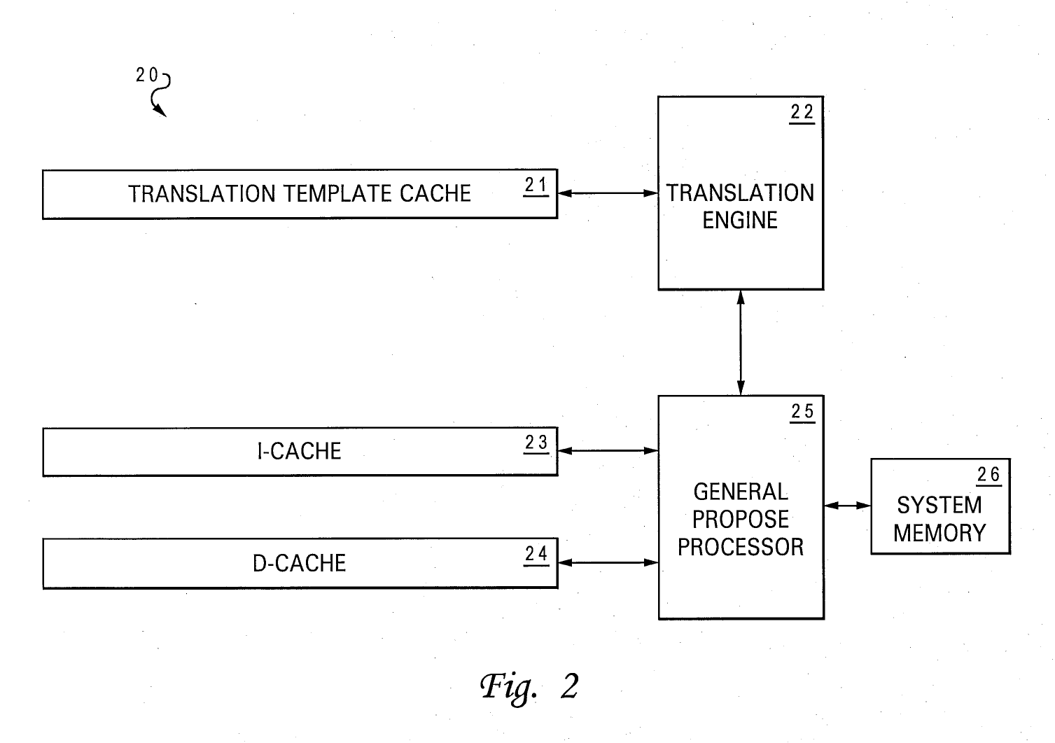

With reference now to FIG. 2, there is illustrated a block diagram of an apparatus for translating data packets from one network protocol to another, in accordance with a preferred embodiment of the present invention. As shown, an apparatus 20 includes a translation template cache 21 and a translation engine 22. Translation engine 22 is coupled to a general purpose processor 25, and general purpose processor 25 is coupled to an instruction cache 23, a data cache 24 and a system memory 26. Apparatus 20 is preferably located within a translation router, such as translation router 15 from FIG. 1. Translation template cache 21 contains translation templates for facilitating the translation of data packets from one network protocol to another. Basically, each translation template within translation template cache 21 represents a unique network protocol supported by the translation router. The use of translation templates requires far lesser instructions to perform a network protocol translation as compared to using general purpose processor 25.

Translation engine 22 may be implemented as software, firmware, hardware, or combinations thereof, and is capable of executing operations necessary to manipulate information in packet headers for protocol translations. Translation template cache 21 may be implemented in a dedicated on-chip memory, whether as one or more locked cache lines or a private memory accessible to translation engine 22.

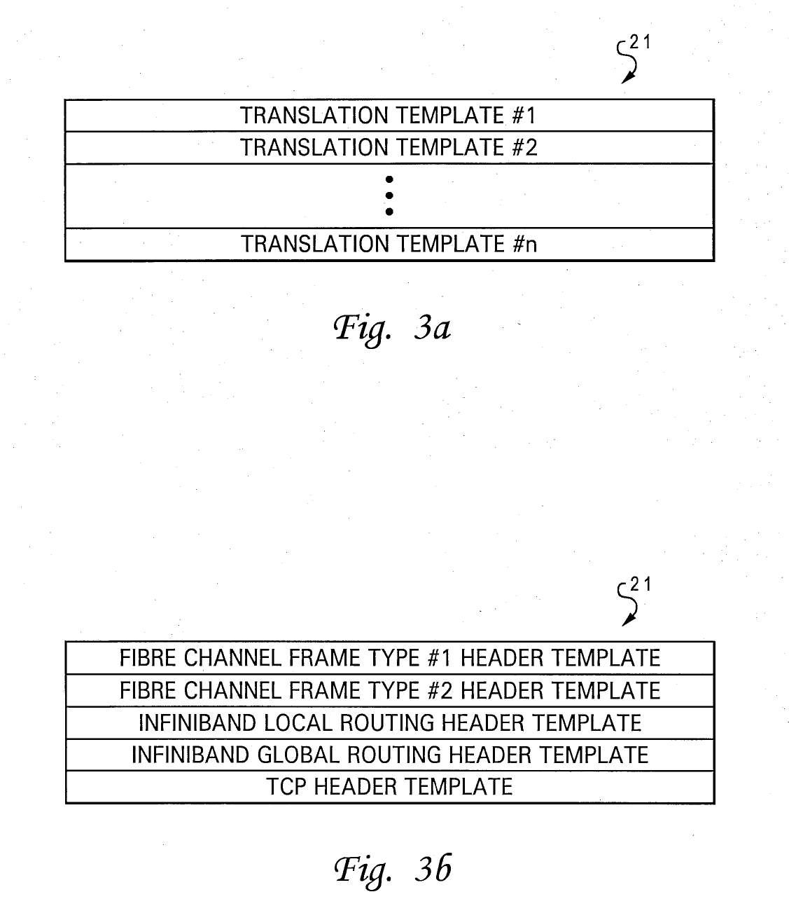

Referring now to FIG. 3a, there is illustrated a block diagram of translation template cache 21, in accordance with a preferred embodiment of the present invention. As shown, translation template cache 21 contains multiple entries, each entry contains a translation template associated with a network protocol supported by a translation router, such as translation router 15 from FIG. 1. Each translation template is preferably 64 bytes wide, which should be long enough to contain headers of data packets of various network protocols.

A translation template is required for each protocol translation. For example, consider a network A and a network B having a protocol A and a protocol B, respectively. One translation template is required for generating data packets suitable for transmission in network B from data packets received from network A. Another translation template is required to generate data packets suitable for transmission in network A from packets received from network B. If there is a third network C having a network protocol C needed to be supported, four more translation templates must be constructed and loaded into the translation template cache. Basically, two translation templates are required for protocol translations between network A and network C, and two translation templates are required for translations between network B and network C.

Five different translation templates associated with their respective network protocols are shown in FIG. 3b. As shown, entry 1 is a translation template for Fibre Channel frame type #1, entry 2 is a translation template for Fibre Channel frame type #2, entry 3 is a translation template for InfiniBand local routing, entry 4 is a translation template for InfiniBand global routing, and entry 5 is a translation template for TCP/IP.

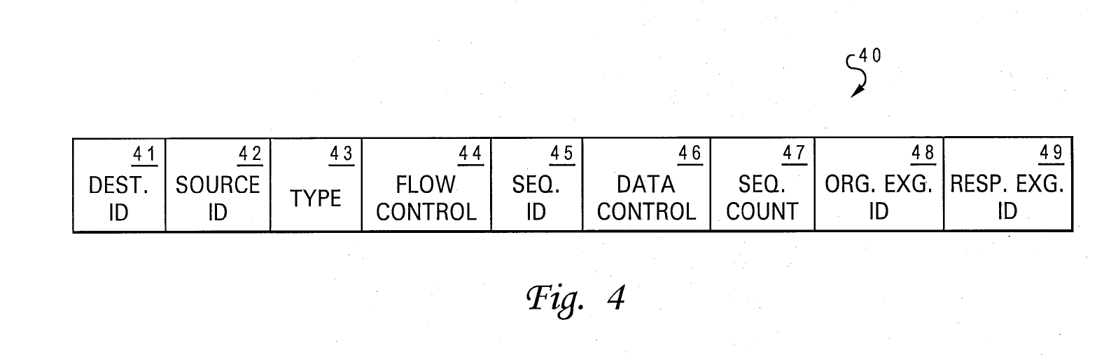

The details of a translation template can be illustrated with an example. The control and information bits of a typical Fibre Channel frame header include:
D_ID: destination identification (ID)
S_ID: source ID
TYPE: protocol of frame content (e.g., 0000 1000=SCSI FCP)
F_CTL: flow control
SEQ_ID: sequence ID
DF_CTL: data_field control
SEQ_CNT: sequence count
OX_ID: originator exchange ID
R: responder exchange ID
Parameter: carries information specific to Link_Control frames
   Thus, a translation template for facilitating the translation of a received data packet to a Fibre Channel protocol should include most, if not all, of the above-mentioned control and information bits. With reference now FIG. 4, there is illustrated a block diagram of a translation template for facilitating the translation of a received data packet to a Fibre Channel protocol, in accordance with a preferred embodiment of the present invention. As shown, a translate template 40 includes a destination ID field 41, a source ID field 42, a type field 43, a flow control field 44, a sequence ID field 45, a data control field 46, a sequence count field 47, an originator exchange ID field 48, and a responder exchanged ID field 49. As shown, the fields within translation template 40 correspond to the fields within the Fibre Channel frame header.

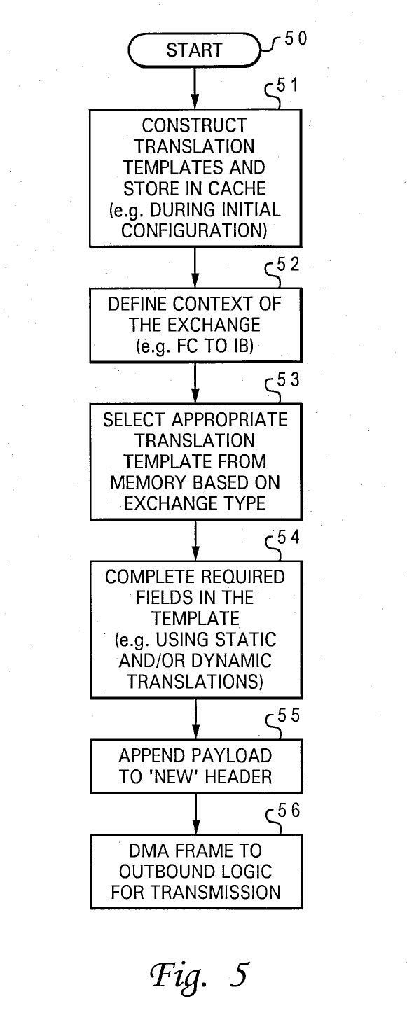

Referring now to FIG. 5, there is depicted a high-level logic flow diagram of a method for translating data packets from one protocol to another by using apparatus 20 from FIG. 2, in accordance with a preferred embodiment of the present invention. Starting at block 30, a group of translation templates are constructed and the translation templates are loaded into a translation template cache, as shown in block 31. The translation templates, such as translation template 40 from FIG. 4, are preferably constructed during initial configuration of a system, and the translation templates are then loaded into the translation template cache. Otherwise, the translation templates can be constructed “on-the-fly” as they are being loaded into the translation template cache.

Next, exchange attributes are identified by a translation router, such as translation router 15 from FIG. 1, as depicted in block 32. At this time, network protocols are also identified, usually as part of the translation engine configuration, and the translation templates are verified as available for use. As mentioned previously, a multi-protocol translation router is capable of identifying the type of network protocol to which a network packet belongs based on the incoming port number the network packet comes from, and is also capable of identifying the type of network protocol to which a network packet should be translated based on the outgoing port number the network packet is to be transmitted.

As each data packet arriving into the translation router, an appropriate translation template is selected from the translation template cache according to the translation context of the data packet by an translation engine, as shown in block 33.

Appropriate header fields from the data packets from a first network are read and used by the translation engine along with the appropriate translation template in the translation template cache to generate new headers for transmission into a second network, as depicted in block 34.

The data payload of the data packet from the first network is removed from the header of the data packet, and is then appended to the recently constructed header for the second network, as shown in block 35. The resultant data packet intended for the second network is then placed into a local memory of the network router.

The data packet intended for the second network is subsequently pulled out of the local memory within the network router. This is usually performed by using a direct memory access (DMA) or by the general-purpose processor, as depicted in block 36. The data packet intended for the second network is sent to the second network.

As has been described, the present invention provides an improved method and apparatus for translating data packets between different network protocols. Control blocks are constructed in a system memory to facilitate translation from one protocol domain to another. They must be repeatedly accessed as part of the translation process. With the present invention, the control blocks are stored on-chip in a manner that facilitates repeated use over a number of data packets. Further, the on-chip storage is not bound to one protocol format or another. In this way, packets may be translated across such protocols as Fibre Channel, Ethernet and InfiniBand.

It is also important to note that although the present invention has been described in the context of a fully functional translation router, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for translating data packets from one network protocol to another, said method comprising:
constructing a plurality of translation templates;
loading said plurality of translation templates into a translation template cache;
in response to a data packet from a first network arriving at a translation router, selecting an appropriate one of said plurality of translation templates from said translation template cache according to the translation context of said data packet;
generating a new header for transmission into a second network by reading header fields of said data packet from said first network along with said appropriate one of said plurality of translation templates in said translation template cache;
removing data payload of said data packet from said first network from its header;
appending said data payload of said data packet to said constructed header for said second network; and
transmitting said data packet to said second network.

2. The method of claim 1, wherein said plurality of translation templates includes translation templates for Fibre Channel, translation templates for Ethernet and translation templates for InfiniBand.

3. The method of claim 1, wherein said translation template cache is a dedicated on-chip memory.

4. The method of claim 1, wherein said selecting further includes selecting an appropriate one of said plurality of translation templates from said translation template cache according to an incoming port number from which said data packet comes.

5. The method of claim 1, wherein said generating further includes generating a new header for transmission into a second network according to an outgoing port number to which said data packet is to be transmitted.
